(19) United States
(12) Patent Application Publication
(10) Pub. No.: US 2007/0116911 A1
(43) Pub. Date: May 24, 2007

(54) Hot seal resins

(75) Inventors: Mark B. Miller, Houston, TX (US); Juan Jose Aguirre, League City, TX (US); David L. Turner, Pasadena, TX (US); Michael A. McLeod, Kemah, TX (US); David K. Young, Deer Park, TX (US)

Correspondence Address: FINA TECHNOLOGY INC, PO BOX 674412, HOUSTON, TX, 77267-4412, US

(73) Assignee: Fina Technology, Inc.

(21) Appl. No.: 11/284,536

(22) Filed: Nov. 21, 2005

(51) Int. Cl. B32B 27/08; B32B 27/00

(52) U.S. Cl. 428/35.7; 428/411.1

(57) ABSTRACT

A film having a seal strength of at least 100 grams force/inch and a seal initiation temperature of less than about 100 ° C. A polymeric composition comprising a metallocene catalyzed random ethylene-propylene copolymer and a propylene/alpha olefin copolymer or ethylene/alpha olefin copolymer. An article comprised of a film having a seal strength of at least 100 grams force/inch and a seal initiation temperature of less than about 100 ° C.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates to polymeric compositions and end-use articles made from same. More specifically, this invention relates to polymeric compositions for production of flexible packaging containers with improved thermal properties.

### BACKGROUND OF THE INVENTION

Flexible packaging materials are widely used in the packaging of a variety of consumer products. The flexible packaging industry has many challenging aspects in terms of the requirements for high-speed manufacturing of the product, the durability of the packaging container and the packaging container aesthetics. Packaging operations have been forced to become increasingly faster and more reliable which induces even higher demands on materials and process knowledge. Depending on the manufacturing method used, the durability of the packaging container can play an important role in the overall manufacturing efficiency. One such manufacturing method employs form fill seal (FFS) systems.

FFS systems begin with the formation of a packaging container, then a product is used to fill the container and the container is subsequently sealed for storage and/or shipping. Manufacturing efficiency depends on the ability of the packaging system to rapidly form a container that is sufficiently durable to withstand being filled almost immediately with consumer product. The ability of the container to withstand subsequent processing steps immediately following formation depends on the integrity of the seals created when the packaging container is formed. Heat sealing is the major technique used for forming and closing flexible packages. Heat is used to rapidly activate a sealant layer comprised of a heat sealable material, usually a polymeric resin. The short time the heating apparatus is in contact with the container material requires that the sealant layer activate quickly to form a durable seal.

The manufacturing efficiency is also affected by the amount of heat required to activate the heat sealable material. The temperature required to activate the heat sealable material and form a durable seal is termed the seal initiation temperature (SIT) and the ability of the seal to resist opening immediately after being formed is termed hot tack. The temperature range over which a durable seal can be formed and maintained is termed the hot tack window. Heat sealable materials requiring high temperatures to activate may negatively affect the manufacturing efficiency both in terms of the equipment needed to generate the appropriate temperatures and the impact of these conditions (i.e. high temperatures) on the consumer product.

Given the foregoing discussion, it would be desirable to develop a sealant layer having a low SIT. Furthermore, it would be desirable to develop a sealant layer having a broad hot tack window.

### BRIEF SUMMARY OF SOME OF THE PREFERRED EMBODIMENTS

Disclosed herein are a film having a seal strength of at least 100 grams force/inch and a seal initiation temperature of less than about 100° C. and a polymeric composition comprising a metallocene catalyzed random ethylene-propylene copolymer and a propylene/alpha olefin copolymer or ethylene/alpha olefin copolymer.

Further disclosed herein is an article comprised of a film having a seal strength of at least 100 grams force/inch and a seal initiation temperature of less than about 100° C.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a graphical comparison of seal initiation temperatures.

FIG. 2 is a graphical representation of seal strength.

FIG. 3 is a graphical comparison of the heat seal curves.

FIG. 4 is a graphical comparison of seal initiation temperatures.

FIG. 5 is a graphical representation of seal force.

FIG. 6 is a graphical representation of hot tack strength.

### DETAILED DESCRIPTION OF THE PREFERRED EMBODIMENTS

Intermediate and end-use articles are prepared from a polymeric composition comprising a metallocene-catalyzed polymer of propylene (mPP) and a modifier. The mPP may be a homopolymer or a copolymer, for example a copolymer of propylene with one or more alpha olefin monomers such as ethylene, butene, hexene, etc. In an embodiment, the mPP is a random ethylene-propylene (C₂/C₃) copolymer (mREPC) and may comprise of from 1 wt. % to 10 wt. % ethylene, alternatively from 3 wt. % to 6 wt. % ethylene, alternatively 6 wt. % ethylene. The mREPC may have a melting point range of from 100° C. to 155° C., alternatively from 110° C. to 148° C., alternatively from 115° C. to 121° C. Furthermore, the mREPC may have a molecular weight distribution of from 1 to 8, alternatively from 2 to 6. The melting point range is indicative of the degree of crystallinity of the polymer while the molecular weight distribution refers to the relation between the number of molecules in a polymer and their individual chain length.

In random C₂/C₃ copolymers, the ethylene molecules are inserted randomly into the polymer backbone between repeating propylene molecules, hence the term random copolymer. Without wishing to be limited by theory, it is thought by some that using a metallocene catalyst to form the mPP may allow for better control of the crystalline structure of the copolymer due to its isotactic tendency to arrange the attaching molecules. The metallocene catalyst may ensure that a majority of the propylene monomer is attached so that the pendant methane groups (—CH₃) line up in an isotactic orientation (i.e., on the same side) relative to the backbone of the molecule. The ethylene units do not have a tacticity as they do not have any pendant units, just four hydrogen (H) atoms attached to a carbon backbone (C—C). In an embodiment, homopolymer PP, including the propylene homopolymer portions of copolymers, may be isotactic.

In the preparation of an mREPC, a certain amount of amorphous polymer is produced. This amorphous or atactic PP is soluble in xylene and is thus termed the xylene soluble fraction (XS %). In determining XS %, the polymer is dissolved in hot xylene and then the solution cooled to 0° C. which results in the precipitation of the isotactic or crystalline portion of the polymer. The XS % is that portion of the original amount that remained soluble in the cold xylene. Consequently, the XS % in the polymer is further indicative of the extent of crystalline polymer formed. The total amount of polymer (100%) is the sum of the xylene soluble fraction and the xylene insoluble fraction. In an embodiment, the mREPC has a xylene soluble fraction of from 0.1% to about 6%. Methods for determination of the XS % are known in the art, for example the XS % may be determined in accordance with ASTM D 5492-98.

An example of a suitable mREPC is a metallocene catalyzed ethylene-propylene random copolymer known as EOD02-15 available from Total Petrochemicals USA, Inc. In an embodiment, the mREPC (e.g., EOD02-15) generally has the physical properties set forth in Table 1.

TABLE 1

| | Typical | ASTM |
|---|---|---|
| | Value | Method |
| Resin Properties⁽¹⁾ | | |
| Melt Flow, g/10 min. | 11 | D 1238 |
| Density, g/cc | 0.895 | D 1505 |
| Melting Point, ° F. (° C.) | 246 (119) | DSC⁽²⁾ |
| Film Properties⁽¹⁾ Non-oriented- 2 mil (50 μm) | | |
| Haze, % | 0.3 | D 1003 |
| Gloss @ 45°,% | 90 | D 2457 |
| 1% Secant Modulus (MD), psi (MPa) | 50,000 (345) | D 882 |
| Ultimate Tensile Strength (MD), | 5,000 (35) | D 882 |
| psi (MPa) | | |
| Ultimate Elongation (MD), % | 700 | D882 |
| Heat Seal Temperature⁽³⁾, | 221 (105) | |
| ° F. (° C.) | | |

⁽¹⁾Data developed under laboratory conditions and are not to be used as specification, maxima or minima.
⁽²⁾MP determined with a DSC-2 Differential Scanning Calorimeter.
⁽³⁾Seal condition: die pressure 60 psi (413 kPa), dwell time 1.0 sec

Standard equipment and procedures for polymerizing the propylene and ethylene into a random copolymer are known to one skilled in the art. The REPC may be formed by placing propylene in combination with ethylene in a suitable reaction vessel in the presence of a metallocene catalyst and under suitable reaction conditions for polymerization thereof. Ethylene-propylene random copolymers may be prepared through the use of metallocene catalysts of the type disclosed and described in further detail in U.S. Pat. Nos. 5,158,920, 5,416,228, 5,789,502, 5,807,800, 5,968,864, 6,225,251, and 6,432,860, each of which are incorporated herein by reference.

As noted previously, the polymeric composition may comprise one or more modifiers for the polymer resin (e.g., mREPC). In an embodiment, the modifier comprises a copolymer, alternatively an elastomer. Without wishing to be limited by theory, addition of a copolymer modifier (CM) to the mREPC may provide a rubbery characteristic that enhances mechanical properties such as impact strength and thermal properties such as the SIT. In an embodiment, the CM is a copolymer of propylene and one or more alpha olefins; alternatively the CM is a copolymer of propylene and butene, alternatively a random copolymer of propylene and butene, alternatively a propylene/ethylene/alpha olefin terpolymer; or combinations thereof. In an alternative embodiment, the CM is a copolymer of ethylene and one or more alpha olefins; alternatively the CM is a copolymer of ethylene and butene, alternatively a random copolymer of ethylene and butene; or combinations thereof. The CM may be present in the polymeric composition in amounts of from 1 wt. % to 80 wt. %, alternatively of from 2 wt. % to 50 wt. %, alternatively from 3 wt. % to 30 wt. %, alternatively from 4 wt. % to 25 wt. %, alternatively from 5 wt. % to 20 wt. %.

The CM may have a MWD of from 1.5 to 15, a melting point range of from 60° C. to 140° C., an alpha olefin amount of from 1 wt. % to 50 wt. % and a xylene soluble fraction of from 1% to 50%.

Examples of suitable CMs include without limitation a propylene/butene copolymer sold as TAFMER XRT 101 or a propylene/ethylene/butene terpolymer sold as TAFMER XR107L both by Mitsui Chemicals America Inc. and an ethylene/butene copolymer sold as EXACT 3125 by ExxonMobil Chemical. In an embodiment, the CM (e.g., TAFMER XRT 101) has generally the physical properties given in Table 2.

TABLE 2

| Property | Value |
|---|---|
| Melt Flow Rate g/10 min | 5.84 |
| Xylene solubles (%) | 31.06 |
| Mn | 65486 |
| Polydispersity | 5.6 |
| Mw | 363705 |

The CM may be prepared by any method suitable for the production of a propylene/alpha olefin or ethylene/alpha olefin random copolymer or terpolymer. Such methods are known to one skilled in the art and include slurry polymerization. Catalysts for the formation of the CM include without limitation, olefin polymerization catalysts comprising for example, an organoaluminum oxy-compound and at least two compounds of Group IVB transition metal of the periodic table containing a ligand having a cyclopentadienyl skeleton. Methods, catalyst systems and, conditions for the production of the disclosed CMs are described in U.S. Pat. Nos. 6,774,190 and 6,333,387 each of which are incorporated by reference in their entirety.

In an embodiment, the polymeric composition may also contain additives as deemed necessary to impart desired physical properties. Examples of additives include without limitation stabilizers, antiblocking agents, slip additives, antistatic agents, ultra-violet screening agents, oxidants, anti-oxidants, ultraviolet light absorbents, fire retardants, processing oils, coloring agents, pigments/dyes, fillers, and/or the like with other components. The aforementioned additives may be used either singularly or in combination to form various formulations of the polymer. For example, stabilizers or stabilization agents may be employed to help protect the polymer resin from degradation due to exposure to excessive temperatures and/or ultraviolet light. These additives may be included in amounts effective to impart the desired properties. Effective additive amounts and processes for inclusion of these additives to polymeric compositions are known to one skilled in the art.

The polymeric compositions of this disclosure may be converted to an end-use article by any suitable method. In an embodiment, this conversion is a plastics shaping process such as extrusion, injection molding, thermoforming, blow molding, and rotational molding. Examples of end use articles into which the polymeric composition may be formed include pipes, films, bottles, fibers, containers, cups, lids, plates, trays, car parts, blister packs, and so forth. Additional end use articles would be apparent to those skilled in the art.

In an embodiment, the end-use article is a film, which may be further formed into a packaging container for a consumer product. Such films may be produced by any method and under any conditions known for the formation of a film from a polymeric composition. In an embodiment, the film is produced by a cast film process, alternatively it is produced by a coextrusion cast film process. A cast film process involves extruding melted polymers through a slot or die to form a thin molten sheet or film. The extruded film is then adhered to a cooled surface usually by a blast of air or immersed in a water bath. The blast of air and /or contact with a cooled surface or water bath immediately quenches the film that is then slit at the edges before the film is wound up. In the coextrusion cast film process, two or more molten polymer layers are combined to form a composite extruded film. The combination of molten polymer layers is designed to impart specific physical properties to the film product.

In an embodiment, the film may be a monolayer film with a thickness of from 0.2 mils to 10 mils. Such films may be used as a monolayer film product or may be formulated into a multilayer film product. The polymeric compositions may be processed into a balanced multilayer film product that may be denoted as an A-B-A film product. In this balanced multilayer design, B denotes the core layer of a multilayer structure disposed between some equal number of sealant layers represented by A. The sealant layers may be comprised of the polymeric compositions of this disclosure. In an alternative embodiment, the multilayer film product may be denoted as an A-B-C film product. In this multilayer design, the polymeric compositions of this disclosure comprise the A layer or sealant layer while other materials comprise the B and C layers of the film product. Multilayer film structures and methods for their design are known to one skilled in the art. In an embodiment, a packaging container may be formed from the films of this disclosure by folding over the film such that it contacts itself (e.g., layer A or C contacts itself) and a seal is formed with the application of heat.

Films of this disclosure may display improvements in mechanical properties such as tear strength, optical properties such as haze and thermal properties such as SIT. The physical properties discussed herein refer to the properties determined for the monolayer film product produced from the polymeric compositions of this disclosure.

The films of this disclosure may have improved thermal properties such as a reduced SIT and a broadened hot tack window. Herein, the SIT refers to the temperature at which the sealed film product achieves a seal strength of 200 grams/inch while the hot tack window refers to the temperature range over which a seal remains effective (i.e. greater than or equal to 100 grams/inch). In an embodiment, the films of this disclosure have a SIT of less than or equal to 100° C., alternatively of less than or equal to 90° C. and a hot tack window of greater than or equal to 20° C., alternatively of greater than or equal to 30° C., alternatively of greater than or equal to 40° C. The SIT and hot tack window may be determined using a heat seal tester in accordance with ASTM F 1921-98 method A.

The films of this disclosure may also display improved optical properties such as reduced haze or increased gloss. Haze indicates the degree to which a film has reduced clarity or cloudiness. In an embodiment, the films of this disclosure have a haze of from 0.1 to 0.5 as determined in accordance with ASTM D 1003. Gloss is a measure of the specular of brilliance of a film. In an embodiment, the films of this disclosure have a gloss at 45° of from 89 to 99 as determined in accordance with ASTM D 2457.

The films formed using the polymeric compositions of this disclosure may display a tensile strength at break in the machine direction (MD) of from 20 to 50 MPa; a tensile strength at break in the transverse direction (TD) of from 15 to 40 MPa; a tensile break strength elongation at break MD of from 300 to 700%; a tensile break strength elongation at break TD of from 300 to 700%; a 1% secant modulus MD of from 240 to 420 MPa; and a 1% secant modulus TD of from 220 to 410 MPa. Tensile strength at break and tensile break strength elongation both indicate the degree of deformation of the material at the point of rupture and are determined in accordance with ASTM D 882. The percentage secant moduli specifications refer to the ratio of stress to strain deformation as determined in accordance with ASTM D 882.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner. Unless otherwise indicated, physical properties were determined in accordance with the test methods previously identified in the detailed description.

### Comparative Example

A comparison of the optical and thermal properties of Ziegler-Natta catalyzed REPC and metallocene catalyzed REPC films were made. Film products were prepared from four samples of ethylene-propylene random copolymers. Table 3 lists the catalyst used to prepare the resins, the weight % ethylene for each composition and physical properties of film products formed from each resin.

TABLE 3

| | | | Melting | | | |
|---|---|---|---|---|---|---|
| | Cata- | % | Point | | Haze | SIT |
| Product | lyst* | Ethylene** | (° C.) | Gloss | % | (° C.) |
| 8573 | ZN | 5 | 134 | 85 | 2.8 | 117 |
| Z9470 | ZN | 7 | 129 | 55 | 8 | 112 |
| EOD01-03 | M | 2.3 | 134 | 90 | 1 | 115 |
| EOD02-15 | M | 3 | 119 | 92 | 0.5 | 104 |

*ZN = Ziegler-Natta, M = metallocene
**% ethylene = weight % ethylene

An important aspect of this example is the comparison is made between heat sealable polymers having similar melting points that are prepared from either a Ziegler-Natta or metallocene catalyst. The results demonstrate that metallocene catalyzed polymeric resins display improved optical properties when compared to Ziegler-Natta catalyzed resins. Specifically there is an increased in gloss and a reduction in haze for the metallocene catalyzed resins.

### Example 1

Polypropylene-based random copolymer and terpolymer resins were used as heat seal layers in coextruded films. The thermal and mechanical properties of three heat seal resins were compared; a heat sealant terpolymer F337D and TAFMER XD a propylene alpha olefin copolymer both produced by Mitsui and a metallocene catalyzed ethylene-propylene copolymer EOD01-06. by Total Petrochemicals USA, Inc. Cast monolayer films of 2-mil thickness were extruded on a Egan cast film line under standard conditions. Observations from extrusion of the materials are provided in Table 4. Herein, plate-out refers to the accumulation of material on the quench surface. This material is usually attributed to the presence of low molecular weight polymer or incompatible additives. As this material is extruded, with time, these substances accumulate and plate-out on the quench surface.

TABLE 4

| | ATOFINA | | |
|---|---|---|---|
| Product | EOD01-06 | F337D | TAFMER- XR |
| Type | Copolymer | Terpolymer | Copolymer |
| Plate-out | Moderate | Moderate | Very Light |
| Haze appearance | Slight | Hazy | Tacky |
| Comments | Slightly Tacky | Not Tacky | Extremely Tacky |

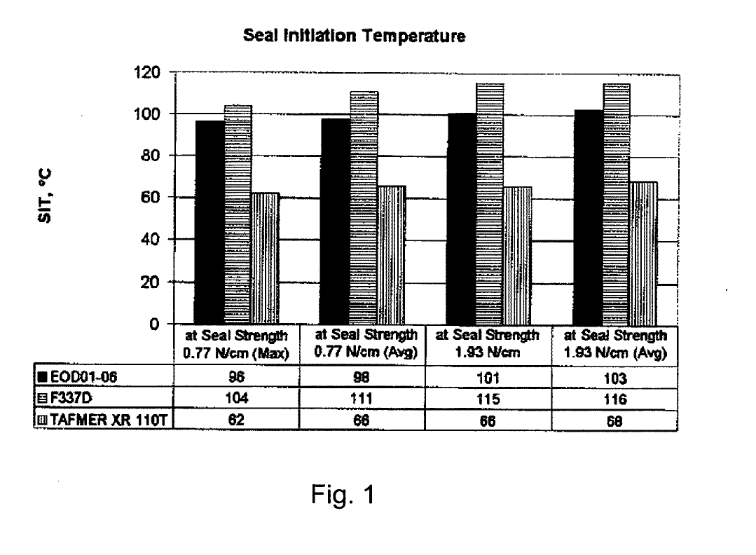

Films from each material were produced and aged for 7 days before conducting hot seal and hot tack tests. The films were aged because polypropylene resins undergo latent crystallization that will force low molecular weight polymer or incompatible additives to the surface and change the mechanical properties of the resin. Allowing for an aging period will permit film properties to stabilize. Referring to FIG. 1, the SIT of EOD01-06, Mitsui F337D and TAFMER XR are compared. The SIT was determined for seal strengths of either 0.77 N/cm or 1.93 N/cm. The average values of the SIT for the indicated seal strengths are given in columns 2 and 4 of FIG. 1. Based on this criterion, EOD01-06 exhibited an average SIT of 98° C., which is much improved over Mitsui F337D, which had an average SIT of 111° C. TAFMER XR was difficult to extrude and had an average SIT of 66° C. however, due to processing challenges, TAFMER XR was subsequently used as a modifier. Specifically, TAFMER XR when processed neat was observed to be extremely tacky. This characteristic lead to processing challenges as it results in a tendency to stick to surfaces. Consequently, for processing on typical cast film extrusion equipment, TAFMER XR is more easily handled as a blend component.

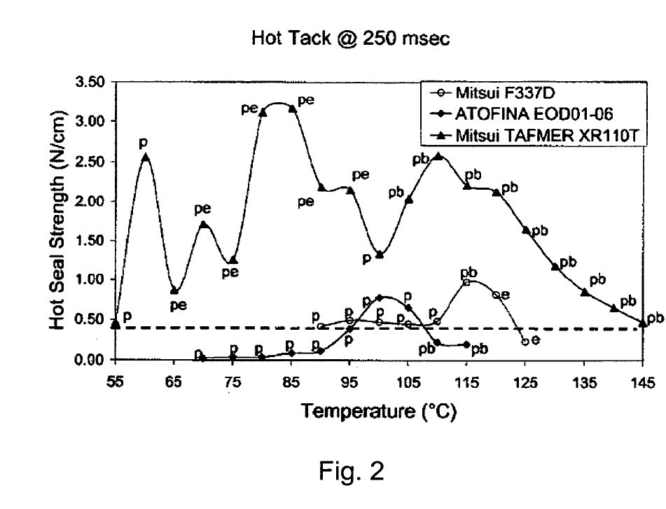

FIG. 2 compares the hot tack performance for the three heat sealable materials as a function of seal temperature. Failure modes for heat seal are denoted peel (p), elongation (e), break (b) or their combination. Hot tack values above 104 g/in (0.4 N/cm) were generally accepted as sufficient for effective hot tack seal strength. TAFMER XR was determined to have excellent hot tack seal strength.

### Example 2

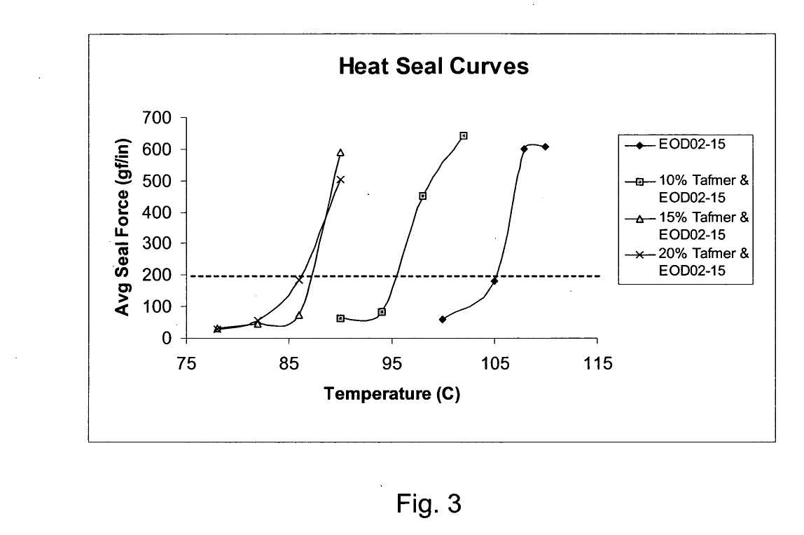

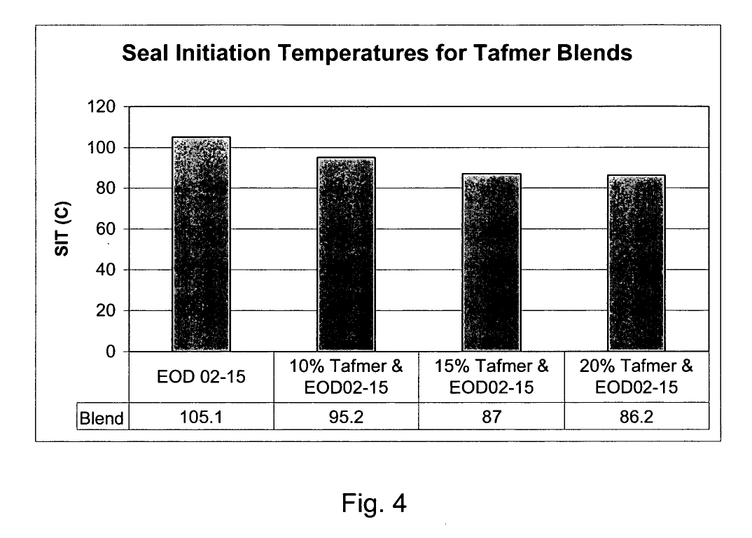

Melt blends were prepared by the addition of 10%, 15%, or 20% of the copolymer CR TAFMER XR 110T to the mREPC EOD02-15. CR TAFMER XR 110T is a propylene/butene copolymer containing 31% butene and 69% propylene. CR TAFMER XR 110T has a MFR of 7, a melting point of 109° C., a recrystallization temperature of 54° C., and a XS % of 43. EOD02-15 is a 12 MFR mREPC with a melting point of 119° C. Two mil cast film sample of each blend was prepared on the Egan cast film line and heat seal properties were determined using a Theller heat-seal tester. The effects of blending differing amounts of CR TAFMER XR 110T on the heat seal curves of EOD02-15 is shown in FIG. 3 while the effects on the SIT are shown in FIG. 4. The data on the SIT and hot tack window are tabulated in Table 5.

TABLE 5

| | | Low Hot | High Hot | |
|---|---|---|---|---|
| | Avg Force | Tack Temp | Tack Temp | |
| | SIT @ | @ 0.4 N/cm | @ 0.4 N/cm | Hot Tack |
| | 0.77 N/cm | @ 250 msec | @ 250 msec | window |
| Resin | ° C. | ° C. | ° C. | ° C. |
| EOD02-15-100% | 99.3 | 86.7 | 110.2 | 23.5 |
| EOD02-15 100% | 101.7 | 88.9 | 111.7 | 22.8 |
| EOD02-15 90% | 95.2 | 78.2 | 109.9 | 31.7 |
| TAFMER 10% | | | | |
| EOD02-15 85% | 87 | 67 | 113.9 | 46.9 |
| TAFMER 15% | | | | |
| EOD02-15 80% | 86.2 | 68.5 | 93.2 | 24.7 |
| TAFMER 20% | | | | |

The data demonstrates that blends containing 10 wt. % CR TAFMER XR 110T and EOD02-15 had a displaced heat seal resulting in a the SIT that was 10° C. lower than the composition in the absence of the copolymer modifier. Increasing the CR TAFMER XR 110T content to 15% further decreased the SIT by another 8° C. In addition, blends containing the CR TAFMER XR 110T had a hot tack window that was increased by 48% from 22.8° C. to 46.9° C. Clearly the addition of the CM to the mREPC results in improved thermal properties. No significant improvements in the SIT were observed in blends containing greater than 15% CR 110T TAFMER XR.

### Example 3

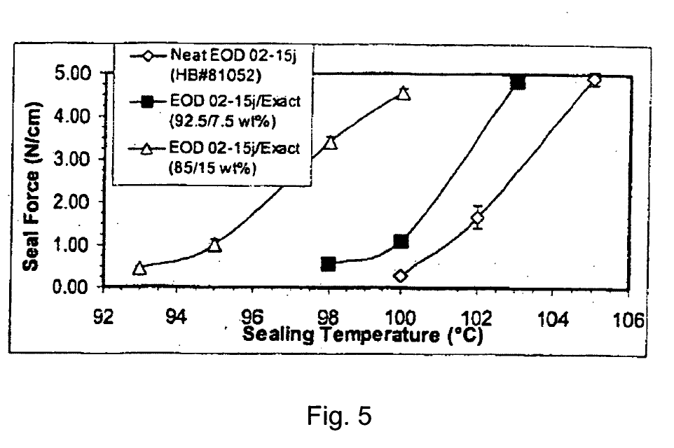

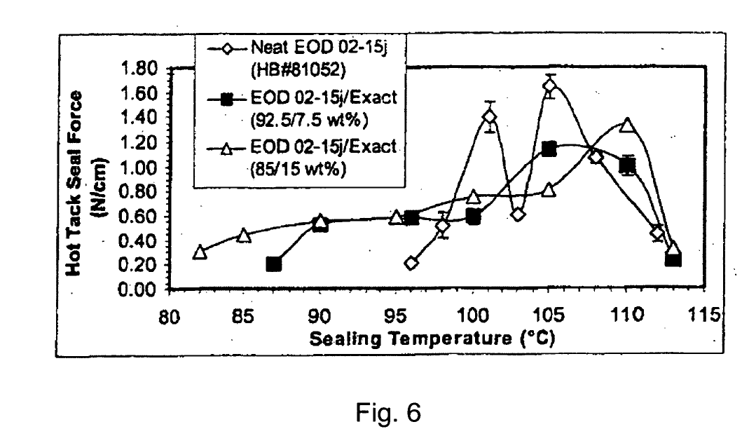

The thermal properties of two samples of the mREPC, EOD02-15 with either 7.5 wt. % or 15 wt. % of the ethylene/alpha olefin copolymer EXACT 3125 were compared to that of the EOD02-15 base resin. Samples were prepared and tested as described in Example 2. FIG. 5 is a graph of the heat seal strength versus heat seal temperature for the base resin and the resin containing either 7.5 wt. % or 15 wt. % of the ethylene/alpha olefin copolymer EXACT 3125 while FIG. 6 is a graph of the hot tack strength 250 ms after sealing. The data demonstrates the reduction in the SIT and broadening of the hot tack window with increasing additions of EXACT 3125.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A film having a seal strength of at least 100 grams force/inch and a seal initiation temperature of less than about 100° C.

2. The film of claim 1 comprising a polymeric resin comprising polypropylene and a modifier.

3. The film of claim 2 wherein the polypropylene is a random ethylene-propylene copolymer.

4. The film of claim 3 wherein the random ethylene-propylene copolymer is metallocene catalyzed.

5. The film of claim 4 wherein the homopolymer portion of the random ethylene-propylene copolymer is isotactic.

6. The film of claim 4 wherein the random ethylene-propylene copolymer has a xylene solubles content of from 0.1% to 6%.

7. The film of claim 4 wherein the random ethylene-propylene copolymer has an ethylene content of from 1 wt. % to 10 wt. %.

8. The film of claim 4 wherein the random ethylene-propylene copolymer has a melting point of from 100° C. to 155° C.

9. The film of claim 2 wherein the modifier comprises a copolymer, a terpolymer or combinations thereof.

10. The film of claim 9 wherein the copolymer comprises propylene and one or more alpha olefins or ethylene and one or more alpha olefins.

11. The film of claim 10 wherein the alpha olefin is butene, ethylene, propylene or combinations thereof.

12. The film of claim 2 wherein the modifier is present in an amount of from 1 wt. % to 80 wt. %.

13. The film of claim 1 having a gloss at 45° of from 89 to 99 as determined in accordance with ASTM D 1003.

14. The film of claim 1 having a hot tack window of greater than 20° C.

15. A polymeric composition comprising a metallocene catalyzed random ethylene-propylene copolymer and a propylene/alpha olefin copolymer or ethylene/alpha olefin copolymer.

16. The composition of claim 15 wherein the metallocene catalyzed random ethylene-propylene copolymer has an ethylene content of from 1 wt. % to about 10 wt. %.

17. The composition of claim 15 wherein the propylene/alpha olefin copolymer or ethylene/alpha olefin copolymer comprises from 1 wt. % to 80 wt. % of the total polymeric composition.

18. An article comprised of a film having a seal strength of at least 100 grams force/inch and a seal initiation temperature of less than about 100° C.

19. The article of claim 18 comprises a monolayer film or multilayer film.

20. The article of claim 18 is a flexible packaging container for a consumer product.
